(19) United States
(12) Patent Application Publication
(10) Pub. No.: US 2023/0240260 A1
(43) Pub. Date: Aug. 3, 2023

(54) Natural Nipple Feeding System

(71) Applicant: Brandi Lauder, Woodland, PA (US)

(72) Inventor: Brandi Lauder, Woodland, PA (US)

(21) Appl. No.: 17/591,703

(22) Filed: Feb. 3, 2022

(51) Int. Cl. A01K 9/00

(52) U.S. Cl. CPC A01K 9/005

(57) ABSTRACT

A utensil that is shaped like a nipple is used to provide nutritional support to a newborn. The nipple will reduce or eliminate the risk of aspiration while feeding by allowing more control over the fluid flow. This utensil is made with a soft, flexible and porous tip to mimic the mother's teats giving the newborn the desire to latch on with vigor and nurse until full. Because of the design and material used, it also allows for easier reconnection with the mother after initiating supplemental feeding. The utensil has a syringe to allow a constant flow of fluid for uninterrupted feeding. The nipple can be sterilized, and reused until wore.

### APPENDIX

The present application comprises an appendix labeled as “Appendix-A” the entire contents of which are hereby incorporated by reference.

### FIELD OF THE INVENTION

The present invention relates to a way to nurse puppies kittens and any other animal in need of nutritional support.

### BACKGROUND

Unfortunately, there are many lives lost due to a need for nutritional support due to many circumstances concerning animals. Large litters, underdeveloped newborn, or abandonment. Many feeding systems do not feel natural to a newborn which makes it very difficult for them to latch on to nurse. Most feeding systems have a flow that is too fast for the animal to regulate the amount needed to satisfy it. When hand feeding aspirating is by far the most common problem causing unnecessary deaths. Sometimes an animal only needs a little help to get started. With the standard feeding systems you see on the market today it makes it very difficult for the newborn to latch back onto its mother because the nipple does not feel natural and the flow is way too slow the animal gives up sucking because it is not being satisfied quick enough. Unfortunately, without intervention, the animal would die of starvation. Mothers' milk is by far the best option for any offspring but when necessary hand feeding is a must. It is beneficial to re-unite the offspring with the mother as soon as possible. The best-case scenario is to hand feed for a couple of days instead of weeks.

### BRIEF SUMMARY OF THE INVENTION

The present invention seeks to provide a solution to the problem(s) by providing a feeding system that allows the animal to regulate the flow of milk comfortably for the animal. Also to provide a nipple that feels natural to them. Allowing them to return to their mother if applicable.

### BRIEF DESCRIPTION

The feeding system is a nipple made from a porous sponge like material attached to a Luer lock tip syringe bottle or bucket for a natural flow and continuous feed.

### DETAILED DESCRIPTION OF THE INVENTION

The terminology used herein is to describe particular embodiments only and is not intended to be limiting of the invention. As used herein, the term “and/or” includes all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or some cases all, of the other disclosed techniques. Accordingly, for the sake of clarity, this description will refrain from repeating every possible combination of the individual steps in an unnecessary fashion Nevertheless, the specification and claims should be read with the understanding that such combinations are entirely within the scope of the invention and the claims.

The natural nipple feeding system is discussed herein. In the following description, for purposes of explanation, numerous specific details are outlined to provide a thorough understanding of the present invention. It will be evident, however, to one skilled in the art that the present invention may be practiced without these specific details.

The present disclosure is to be considered as an exemplification of the the invention, and is not intended to limit the invention to the specific embodiments illustrated by the figures or description below.

The natural nipple feeding system is made with a porous nipple sponge-like material that can be made with Cellulose wood fibers foam plastic hemp fiber but not limited to these materials. Any soft porous material can be used. The nipple can be made into any shape size or texture as long as the nipple remains to be soft porous and flexible.

A component of rubber plastic or cork but not limited to these materials can be inserted and secured in nipple with a non toxic adhesive for attachment to fit any feeding device by screwing or pushing the nipple on to the device. Such as a luer lock tip syringe bottle , or bucket. The component can have a extended tube to release the milk deeper into the nipple to ensure the milk does not accumulate at the base of the nipple. A small hole at the bottom of the nipple to insert the end of the syringe can be used alone with out any component.

### BRIEF DESCRIPTION OF THE DRAWINGS

FIG. 1. (A) Soft flexible porous nipple to extract fluid from.

FIG. 2. (B) Base of nipple with whole to insert syringe tip

FIG. 3. (C) Extender tip to secrete fluid close to end of nipple.

FIG. 4. (D) Syringe with extender attached ready to insert into base of nipple.

FIG. 5. (A B C D) Connected together and ready to use.

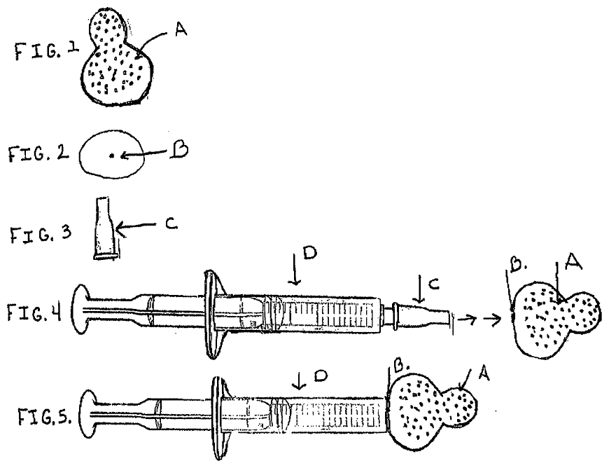

1. A feeding utensil used for small animals such as puppies and kittens comprised of a soft, flexible, and absorbable material in which fluid is inserted and saturated by way of a syringe A syringe that incorporates an elongated tip or an extension piece.

2. According to claim 1, wherein the feeding utensil fluid is inserted by way of a syringe with an elongated tip or extension that is inserted deeply into an absorbable non-toxic material such as a sponge, made from natural sponge, Cellulose, wood fibers, hemp fiber, foam, or plastic.

3. According to claim 2 wherein the feeding utensil will allow a continuous flow of fluid without interruption while feeding the baby animal by enabling the administrator to have total control of the distribution of fluid that is saturated into said sponge nipple by inserting and extracting fluid as needed by pushing or pulling plunger from said syringe.

4. According to claim 3, wherein the feeding utensil will reduce aspiration while feeding by allowing precise control of amount and flow of the fluid that is administered to and removed from the newborn animal to ingest.

5. According to claim 1, wherein the feeding utensil will and mimic the feel of the mother's teat, which allows the baby animal to reconnect with their mother with more ease for the reason that the nipple is made with a soft porous material that feels like animal skin tissue.

6. According to claim 1, wherein the feeding utensil fluid will be given by way of a syringe with either an elongated tip or extension piece such as a tube, this will release the milk deeper into the porous sponge-like material, said nipple, so fluid does not accumulate at the base of the nipple.

7. According to claim 6, wherein the feeding utensil with the use of a syringe with either an elongated tip or extension piece or both combined will help reduce aspiration and gas for the reason that the elongated tip or extension leaves little space for air to accumulate. It delivers milk to the end of the nipple, where the baby animal has more control over how much milk it wants to intake by virtue of the sponge-like nipple, and the elongated tip or extension fluid can also be extracted from the baby animal's mouth if it consuming too much at one time by pulling out on the plunger the sponge will absorb any excess fluid in the baby animals mouth.
